(19) United States
(12) Patent Application Publication
(10) Pub. No.: US 2024/0008681 A1
(43) Pub. Date: Jan. 11, 2024

(54) PELLET GRILL WITH OPEN FLAME SWITCH

(71) Applicant: Hangzhou Yixiang Technology R&D Co., LTD, Hangzhou (CN)

(72) Inventors: Baichen Dong, Newark, CA (US); Yulin Ye, Hangzhou (CN); Jianing Zhu, Shanghai (CN); Bingchen Jin, Hangzhou (CN); Zhiling Lian, Shenzhen (CN)

(21) Appl. No.: 17/878,891

(22) Filed: Aug. 1, 2022

(30) Foreign Application Priority Data
Jul. 8, 2022 (CN) 202221780893.2

(51) Int. Cl. A47J 37/07

(52) U.S. Cl. CPC A47J 37/0704; F24B 13/04

(57) ABSTRACT

Disclosed is a pellet grill with an open flame switch. The grill includes a housing with an opening, a pellet bin and a burning bin. The grill further includes an oil baffle and an open flame baffle. the burning bin is provided with a burning chamber, pellets in the pellet bin are conveyed to the burning chamber to be burnt, the oil baffle is positioned above the burning chamber, the oil baffle is slidably provided with the open flame baffle, the oil baffle is provided with flame outlet grooves, and the open flame baffle can be moved so as to close and open the flame outlet grooves. With the above design, the oil baffle is further provided with the open flame baffle, and the flame outlet grooves can be blocked only by stirring the open flame baffle, such that use is easy, and safety is high.

### CROSS REFERENCE TO RELATED APPLICATIONS

The present application claims the benefit of Chinese Patent Application No. 202221780893.2 filed on Jul. 8, 2022, the contents of which are incorporated herein by reference in their entirety.

### Technical Field

The present disclosure relates to the technical field of grills, in particular to a pellet grill with an open flame switch.

### Background Art

As an outdoor leisure dinner activity, barbecue is really popular with the public because it is suitable for people of all ages, and people can gain a sense of achievement by having a barbecue by themselves. Charcoal or coke is fuel mostly used for a barbecue device, but generates soot, coal slag and coal ash rising along with the wind, which affects appearance and taste of food. Moreover, after being burnt, charcoal will become gray grill ash to be accumulated at the bottom of a grill. Sometimes, combustibles in the grill are required to be extinguished after or during barbecue. At present, combustibles such as soot will be poured out to be doused, which is troublesome, and brings inconvenience to users due to the need of subsequent clearing. Further, if the combustibles are placed directly with flames not shielded and unattended, potential safety hazards are likely to occur.

Accordingly, it is urgent to design a pellet grill with an open flame switch, so as to overcome the defects in the prior art.

### SUMMARY

In order to achieve the above technical objective, the present disclosure employs the following technical solution: a pellet grill with an open flame switch includes a housing with an opening, a pellet bin and a burning bin, the pellet bin being in communication with the burning bin. The grill further includes an oil baffle and an open flame baffle, a bottom wall of the burning bin is provided with a burning chamber, pellets in the pellet bin are conveyed to the burning chamber to be burnt, the oil baffle is positioned above the burning chamber, a top surface of the oil baffle is slidably provided with the open flame baffle, the oil baffle is provided with flame outlet grooves, and the open flame baffle may be moved so as to close and open the flame outlet grooves.

In a preferential embodiment, one end of the open flame baffle is provided with a stirring rod, the stirring rod is vertically arranged, the stirring rod is fixed to the open flame baffle, and the open flame baffle may be driven to move by moving the stirring rod.

In a preferential embodiment, the grill further includes a top cover, the top cover is rotatably connected to the housing, the top cover is provided with a push block, and in the case that the top cover is in a closed state, the push block abuts against the stirring rod, and the open flame baffle closes the flame outlet grooves.

In a preferential embodiment, one end, away from the stirring rod, of the open flame baffle is provided with a limiting portion horizontally extending outwards, one end of the oil baffle is provided with a positioning portion, and the positioning portion is adaptive to the limiting portion.

In a preferential embodiment, two sides of the open flame baffle are provided with limiting slideways, the oil baffle is provided with raised limiting ribs, and the limiting ribs are adaptive to the limiting slideways.

In a preferential embodiment, the open flame baffle includes flame blocking portions, the flame blocking portions are adaptive to the flame outlet grooves, and the flame blocking portions may completely cover the flame outlet grooves.

In a preferential embodiment, the open flame baffle is provided with open flame grooves, and the open flame grooves are positioned between the adjacent flame blocking portions.

In a preferential embodiment, the burning chamber is opposite the flame outlet grooves, and in the case that the open flame baffle opens the flame outlet grooves, the flame outlet grooves are opposite the open flame grooves.

In a preferential embodiment, in a process that the top cover moves from an open position to a closed position, from time when the push block abuts against the stirring rod to time when the top cover is positioned at the closed position, the open flame baffle is driven by the stirring rod to move as the top cover moves.

In a preferential embodiment, one end of the oil baffle is provided with an oil dripping port, and a height of the end, provided with the oil dripping port, of the oil baffle is lower than a height of an end, away from the oil dripping port, of the oil baffle.

Beneficial effects of the present disclosure: according to the present disclosure, an ash clearing pan is arranged in the grill such that grill ash may be conveniently collected. Moreover, the oil baffle is arranged on handles of the ash clearing pan, such that when the grill ash is required to be cleared, the ash clearing pan and the oil baffle may be taken out together by means of the handles, thereby improving cleaning convenience and economic benefits of the grill. In addition, the oil baffle is further provided with the open flame baffle, and the flame outlet grooves may be blocked, when not required, only by stirring the open flame baffle, such that use is easy, and safety is high.

### BRIEF DESCRIPTION OF THE DRAWINGS

FIG. 1 is a schematic structural diagram of the present disclosure;

FIG. 2 is an exploded view of the present disclosure;

FIG. 3 is a schematic structural diagram of an open flame baffle in the present disclosure;

FIG. 4 is a structural view of an oil baffle in the present disclosure;

FIG. 5 is a schematic structural diagram of an ash clearing pan in the present disclosure;

FIG. 6 is a sectional view of a pellet bin in the present disclosure; and

FIG. 7 is a sectional view in the present disclosure.

In the accompanying drawings:

10. housing, 11. pellet bin, 12. material guiding plate, 13. sieve plate, 14. top cover, 15. push block,

20. ash clearing pan, 21. handle, 22. handrail, 23. flame outlet,

30. oil baffle, 31. limiting groove, 32. surrounding edge, 33. oil dripping port, 34. flame outlet groove, 35. limiting rib, 36, positioning portion,

40. open flame baffle, 41. open flame groove, 42, flame blocking portion, 43, limiting slideway, 44. stirring rod, 45. limiting portion,

50. oil dripping pipe, and 51. oil bin.

### DETAILED DESCRIPTION OF THE EMBODIMENTS

In order to enable the above objectives, features, and advantages of the present disclosure to be more apparent and easily understood, specific embodiments of the present disclosure will be described in detail below with reference to the accompanying drawings. Many specific details are set forth in the following description to facilitate full understanding of the present disclosure. However, the present disclosure may be implemented in many other ways different from those described herein, similar improvements may be made by those skilled in the art without departing from the connotation of the present disclosure, and therefore the present disclosure is not limited by the specific embodiments disclosed below.

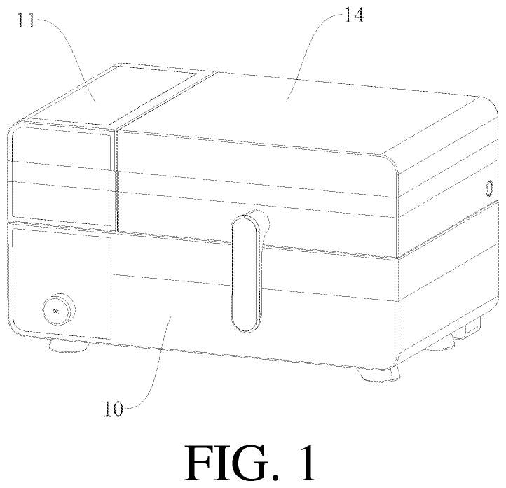

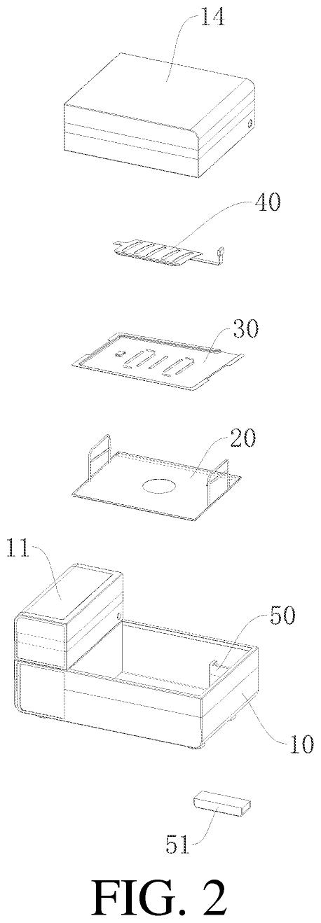

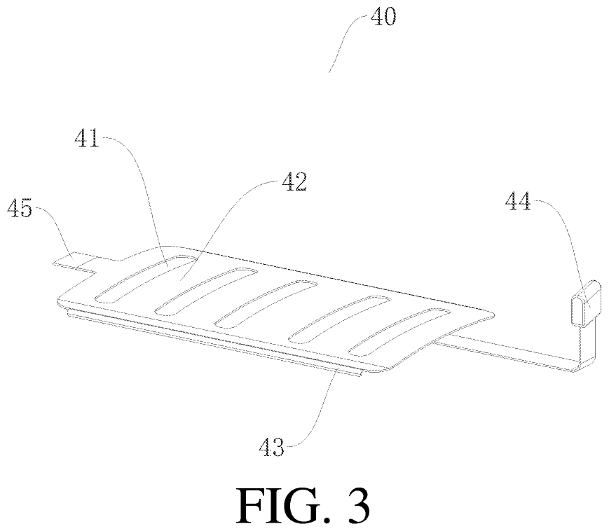

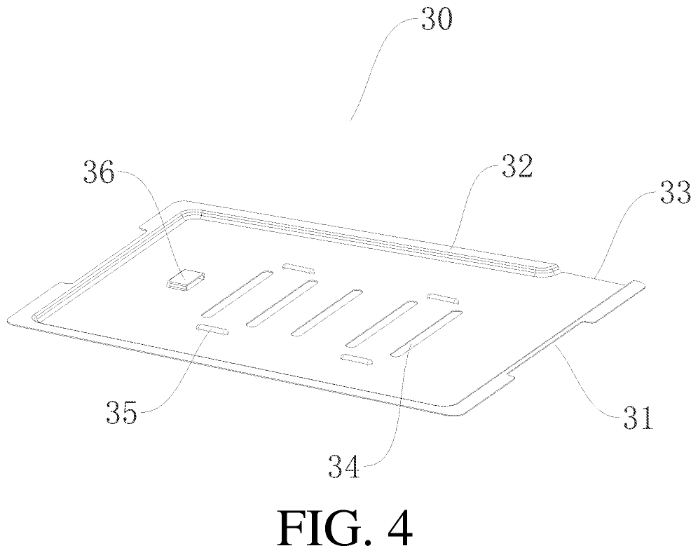

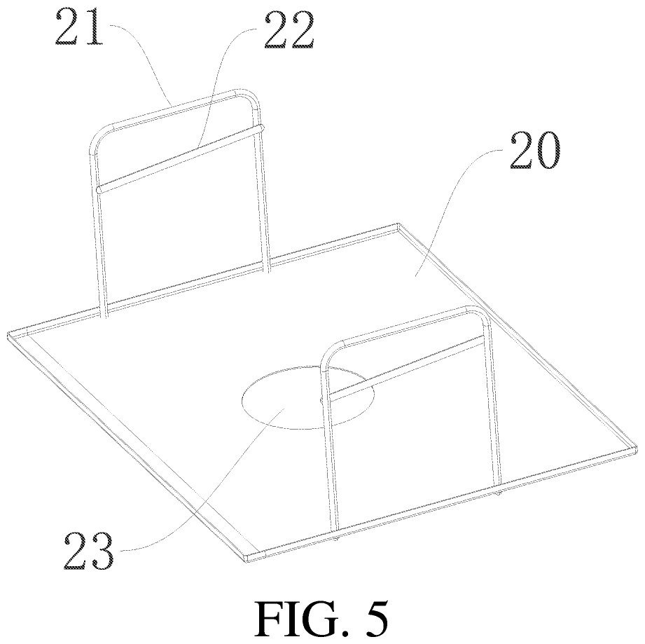

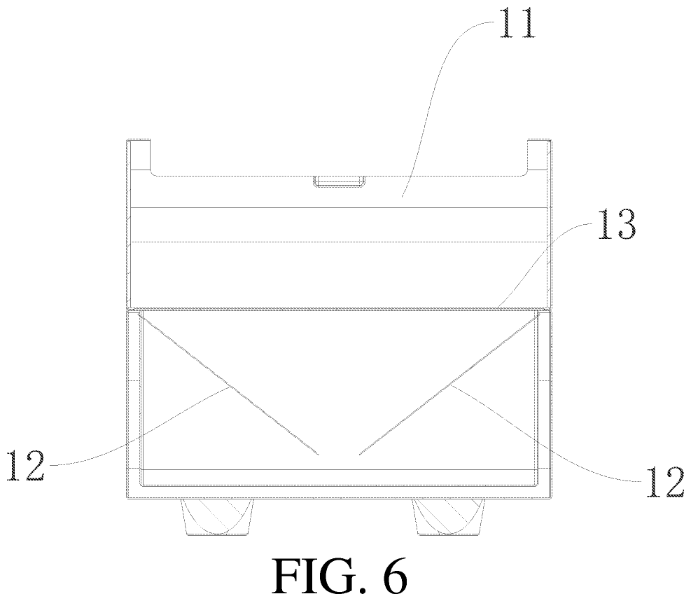

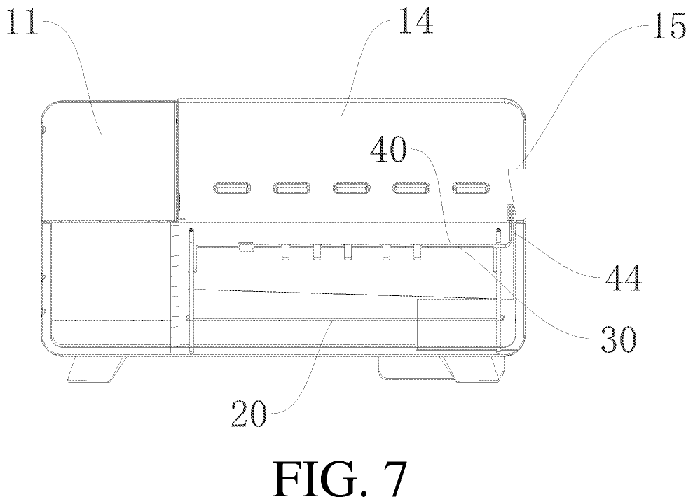

As shown in FIGS. 1-7, the present disclosure provides a pellet grill with an open flame switch. The grill includes a housing 10 with a top opening, one end of the housing 10 is provided with a pellet bin 11, the other end thereof is provided with a burning bin (not shown in the figures), the pellet bin 11 and the burning bin are arranged side by side, and an ash clearing pan 20 and an oil baffle 30 are sequentially arranged above a bottom wall of the burning bin from bottom to top at intervals. Two ends of the ash clearing disc 20 are fixedly provided with handles 21 respectively, two ends of the oil baffle 30 are connected to the corresponding handles 21 respectively, the oil baffle 30 is provided with several flame outlet grooves 34 at intervals, the oil baffle 30 is slidably provided with an open flame baffle 40, the open flame baffle 40 is provided with several open flame grooves 41 corresponding to the flame outlet grooves 34, flame blocking portions 42 are formed between the adjacent open flame grooves 41, and one end of the open flame baffle 40 is provided with a vertical stirring rod 44.

Specifically, the pellet bin 11 is used for carrying pellet combustibles, the burning bin is used for carrying the pellet combustibles in a burning state, a burning chamber is arranged in the burning bin, the burning chamber is positioned at the bottom wall of the burning bin, and the burning chamber is in communication with the pellet bin 11. Pellets in the pellet bin 11 may be conveyed to the burning chamber and are burnt in the burning chamber, the burning chamber is used for collectively carrying the pellet combustibles, and the burning chamber is provided with a top opening such that flames may rush out of the burning chamber when the pellet combustibles are burnt.

The ash clearing pan 20 is partially or completely placed in the burning bin, and the bottom wall of the burning bin supports the ash clearing pan 20, that is, the ash clearing pan 20 abuts against the bottom wall of the burning bin. The ash clearing pan 20 is close to a side wall of the burning bin, and on a plane where a surface of the ash clearing pan 20 is positioned, an area where a distance between the ash clearing pan and the side wall of the burning bin is within 10 mm accounts for not less than 80%, such that the ash clearing pan 20 may better receive dust falling from combustibles, the number of times of cleaning the bottom wall of the burning bin by a user is reduced, and user experience is improved.

A middle of the ash clearing pan 20 is provided with a flame outlet 23, the ash clearing pan 20 is positioned above the burning chamber, the flame outlet 23 is opposite the top opening of the burning chamber, and the flame outlet 23 is used for enabling flames generated when the pellet combustibles are burnt to act on the oil baffle 30 by means of the flame outlet 23. The oil baffle 30 may be used for carrying food, the oil baffle 30 is provided with a plurality of flame outlet grooves 34 at intervals, and flames generated when the pellet combustibles are burnt act on the oil baffle 30 by means of the flame outlet 23, and then act on the food by means of the flame outlet grooves 34, so as to grill the food, thereby achieving grill with open flames. In addition, the oil baffle 30 may be heated to increase a temperature of the oil baffle 30, and then heat is transferred to food to heat the food, so as to heat food not easy to be grilled with open flames, thereby improving taste of the food is improved. Further, a grill body is arranged on the oil baffle 30, and heat of the oil baffle 30 is radiated to the grill body, so as to heat food on the grill body.

An open flame baffle 40 is further slidably arranged above the oil baffle 30, and the oil baffle 30 supports the open flame baffle 40. The open flame baffle 40 is provided with a plurality of open flame grooves 41 corresponding to the flame outlet grooves 34, and the open flame grooves 41 are provided at intervals, so as to form flame blocking portions 42 between the adjacent open flame grooves 41. A plurality of flame blocking portions 42 are arranged, and the size of each flame blocking portion 42 is greater than that of each open flame groove 41. The stirring rod 44 of the open flame baffle 40 is vertically arranged, and the stirring rod 44 is fixed on the open flame baffle 40. When food is required to be grilled with open flames, the stirring rod 44 is stirred to drive the open flame baffle 40 to move, such that the open flame grooves 41 correspond to the flame outlet grooves 34, and flames may act on the food by means of the open flame grooves 41. When open flames are not required for grill, only the stirring rod 44 is required to be stirred to drive the open flame baffle 40 to move, such that the open flame grooves 41 are staggered with the flame outlet grooves 34. The flame blocking portions 42 correspond to the flame outlet grooves 34, and the flame outlet grooves 34 are blocked by the flame blocking portions 42, so as to prevent flames from rushing out, such that grill is achieved without open flames, and leakage of flames and sparks is reduced. When the grill is not used, possibility of causing a fire is reduced, and safety of barbecue is improved.

Further, in the embodiment, two sides of the open flame baffle 40 are provided with limiting slideways 43 respectively, and the open flame baffle 40 is provided with a limiting portion 45 extending horizontally outwards and away from one end provided with the stirring rod 44. Specifically, two sides of the open flame baffle 40 are provided with arc limiting slideways 43 respectively, the limiting slideways 43 are used for enabling the open flame baffle to slide in a specified direction, so as to be prevented form deviating. One end, away from the stirring rod 44, of the open flame baffle 40 is provided with a limiting portion 45, the limiting portion 45 is used for limiting the open flame baffle 40 to continue moving when the open flame baffle 40 slides by a certain distance, such that when the open flame baffle 40 is in this state, the open flame grooves 41 correspond to the flame outlet grooves 34 or the flame blocking portions 42 correspond to the flame outlet grooves 34.

Further, in the embodiment, the oil baffle 30 is provided with raised limiting ribs 35 at two ends of the flame outlet grooves 34, the limiting ribs 35 are adaptive to the limiting slideways 43, one end of the oil baffle 30 is further provided with a positioning portion 36 with an opening at one end, the positioning portion 36 is adaptive to the limiting portion 45, and the limiting portion 45 may be inserted into the positioning portion 36. Specifically, the two ends of the flame outlet grooves 34 are provided with limiting ribs 35 respectively, and the limiting ribs 35 are adaptive to the limiting slideways 43. When the limiting ribs 35 are adaptive to the limiting slideways 43, the open flame baffle 40 may only move in an arrangement direction of the limiting ribs 35, so as to prevent the open flame baffle 40 from deviating, and further reduce deviation between the flame blocking portions 42 and the flame outlet grooves 34. The positioning portion 36 at one end of the oil baffle 30 is adaptive to the limiting portion 45, and the limiting portion 45 may be inserted into the positioning portion 36 when the open flame baffle 40 moves, and is limited by the positioning portion 36 when moving by a limit distance, such that the limiting portion may not move further. When the oil baffle 30 moves to a limit position, the flame blocking portions 42 are positioned right above the flame outlet grooves 34, such that the flame blocking portions 42 completely cover the flame outlet grooves 34.

Further, in the embodiment, a top of each of handles 21 at two ends is provided with a handrail 22 inclined towards one end, and two ends of the oil baffle 30 abut against the handrails 22. Specifically, a top of each handle 21 is provided with a handrail 22 inclined towards one end, and two ends of the oil baffle 30 abut against the handrails 22 respectively. Due to an inclined arrangement of the handrails 22, the oil baffle 30 abutting against the handrails is also inclined towards one side of the housing 10, such that when food is grilled, oil flowing out of the food flows towards a low side due to gravity, and is collected on this side, so as to be conveniently discharged subsequently.

Further, in the embodiment, a top surface of an end of one side of the burning bin is provided with an oil dripping pipe 50, a bottom of the housing 10 is detachably provided with an oil bin 51, and the oil dripping pipe 50 is in communication with the oil bin 51. Specifically, a top of an end of one side of the burning bin is provided with an oil dripping pipe 50, the oil dripping pipe 50 is used for collecting oil and delivering the oil to the oil bin 51, and the oil dripping pipe 50 is positioned at a side towards which a lower position of the oil baffle 30 faces.

Further, two ends of the oil baffle 30 are provided with limiting grooves 31 respectively, and the handles 21 are positioned in the limiting grooves 31. A width of one end of the oil baffle 30 is less than that of the other end, a side portion of the oil baffle 30 is provided with a surrounding edge 32, an end having a larger width of the oil baffle 30 is provided with an oil dripping port 33, and the oil dripping port 33 corresponds to the oil dripping pipe 50. Specifically, the limiting grooves 31 are used for limiting movement of the oil baffle 30, so as to prevent the oil baffle from sliding in an inclined state. Since the width of one end of the oil baffle 30 is less than that of the other end, when the oil baffle 30 is in an inclined state, a position of the wider end is lower than that of the narrower end. Therefore, when oil collectively flows to one side, due to a height difference formed by a narrow end and a wide end, the oil automatically flows to the wider end under the action of gravity, so as to be prevented from accumulating. The wider end of the oil baffle 30 is provided with an oil dripping port 33, and the oil dripping port 33 corresponds to the oil dripping pipe 50, such that oil on the oil baffle 30 may flow into the oil dripping pipe 50 by means of the oil dripping port 33. In order to prevent the oil from dripping from the side of the oil baffle 30, the side of the oil baffle 30 is provided with a surrounding edge 32 for blocking the oil from dripping.

Further, in the embodiment, the grill further includes a top cover 14, one side of the top cover 14 is hinged to one side of a top of the housing 10, and an inner side wall, corresponding to the stirring rod 44, of the top cover 14 is provided with a push block 15. Specifically, when the top cover 14 covers the housing 10, an inner wall of one side, corresponding to the stirring rod 44, of the top cover 14 is provided with a push block 15, and the push block 15 has a thick end and a narrow end, that is, an end, adjacent to the burning bin, of the push block 15 is narrow, and the other end is thick, such that the push block 15 has an inclined surface. In a covering process of the top cover 14, the push block 15 is in contact with and abuts against the stirring rod 44, and as the top cover 14 is continuously closed, the push block 15 continuously drives the stirring rod 44 to move, that is, continuously drive the open flame baffle 40 to move, such that the open flame grooves 41 are staggered with the flame outlet grooves 34, and the flame blocking portions 42 correspond to the flame outlet grooves 34 to block flames from rushing out, thereby extinguishing the open flames. When the top cover 14 is finally in a closed position, the open flame baffle 40 moves to a final position under the combined action of the push block 15 and the stirring rod 44, and in this way, the flame blocking portions 42 completely cover the flame outlet groove 34, that is, the open flame baffle 40 closes the flame outlet groove 34.

Further, in the embodiment, two ends of the pellet bin 11 are internally provided with material guiding plates 12 respectively, and tail ends of the two material guiding plates 12 are inclined towards directions of approaching each other. Specifically, when the pellet combustibles are put into the pellet bin 11, the pellet combustibles collectively flow to one position by means of the material guiding plates 12, collection positions of the material guiding plates 12 correspond to a conveying mechanism, such that the pellet combustibles are directly guided into the conveying mechanism, and then the pellet combustibles are conveyed into the burning chamber by means of the conveying mechanism to be burnt.

Further, in the embodiment, the pellet bin 11 is internally provided with a sieve plate 13 above the material guiding plates 12. Specifically, the sieve plate 13 is used for filtering large pellet combustibles, so as to prevent the conveying mechanism from being blocked and prevent a user from putting fingers into the conveying mechanism.

In summary, according to the present disclosure, an ash clearing pan is arranged in the grill such that grill ash may be conveniently collected. Moreover, the oil baffle is arranged on handles of the ash clearing pan, such that when the grill ash is required to be cleared, the ash clearing pan and the oil baffle may be taken out together by means of the handles, thereby improving cleaning convenience and economic benefits of the grill. In addition, the oil baffle is further provided with the open flame baffle, and the flame outlet grooves may be blocked, when not required, only by stirring the open flame baffle, so as to prevent flames from leaking out, and prevent sparks from leaking out after the machine stops operating, such that use is easy, and safety is high.

The present disclosure is not only limited to the descriptions in the specification and implementations, such that those skilled in the art may easily achieve additional advantages and modifications. Therefore, the present disclosure is not limited to specific details, representative apparatus and illustrative examples shown and described herein without departing from the spirit and scope of the general concept as defined by the append claims and equivalents thereof.

What is claimed is:

1. A pellet grill with an open flame switch, comprising a housing with an opening, a pellet bin and a burning bin, the pellet bin being in communication with the burning bin, wherein the grill further comprises an oil baffle and an open flame baffle, a bottom wall of the burning bin is provided with a burning chamber, pellets in the pellet bin are conveyed to the burning chamber to be burnt, the oil baffle is positioned above the burning chamber, a top surface of the oil baffle is slidably provided with the open flame baffle, the oil baffle is provided with flame outlet grooves, and the open flame baffle can be moved so as to close and open the flame outlet grooves.

2. The pellet grill with an open flame switch according to claim 1, wherein one end of the open flame baffle is provided with a stirring rod, the stirring rod is vertically arranged, the stirring rod is fixed to the open flame baffle, and the open flame baffle can be driven to move by moving the stirring rod.

3. The pellet grill with an open flame switch according to claim 2, further comprising a top cover, wherein the top cover is rotatably connected to the housing, the top cover is provided with a push block, and in the case that the top cover is in a closed state, the push block abuts against the stirring rod, and the open flame baffle closes the flame outlet grooves.

4. The pellet grill with an open flame switch according to claim 3, wherein one end, away from the stirring rod, of the open flame baffle is provided with a limiting portion horizontally extending outwards, one end of the oil baffle is provided with a positioning portion, and the positioning portion is adaptive to the limiting portion.

5. The pellet grill with an open flame switch according to claim 1, wherein two sides of the open flame baffle are provided with limiting slideways, the oil baffle is provided with raised limiting ribs, and the limiting ribs are adaptive to the limiting slideways.

6. The pellet grill with an open flame switch according to claim 1, wherein the open flame baffle comprises flame blocking portions, the flame blocking portions are adaptive to the flame outlet grooves, and the flame blocking portions can completely cover the flame outlet grooves.

7. The pellet grill with an open flame switch according to claim 6, wherein the open flame baffle is provided with open flame grooves, and the open flame grooves are positioned between the adjacent flame blocking portions.

8. The pellet grill with an open flame switch according to claim 7, wherein the burning chamber is opposite the flame outlet grooves, and in the case that the open flame baffle opens the flame outlet grooves, the flame outlet grooves are opposite the open flame grooves.

9. The pellet grill with an open flame switch according to claim 3, wherein in a process that the top cover moves from an open position to a closed position, from time when the push block abuts against the stirring rod to time when the top cover is positioned at the closed position, the open flame baffle is driven by the stirring rod to move as the top cover moves.

10. The pellet grill with an open flame switch according to claim 1, wherein one end of the oil baffle is provided with an oil dripping port, and a height of the end, provided with the oil dripping port, of the oil baffle is lower than a height of an end, away from the oil dripping port, of the oil baffle.
